(19) United States
(12) Patent Application Publication
(10) Pub. No.: US 2003/0041002 A1
(43) Pub. Date: Feb. 27, 2003

(54) Method and system for conducting an auction for electricity markets

(75) Inventors: Shangyou Hao, Walnut, CA (US); Dariush Shirmmohammadi, Beverly Hills, CA (US)

Correspondence Address: Gary B. Solomon, Jenkens & Gilchrist, P.C., 3200 Fountain Place, 1445 Ross Avenue, Dallas, TX, 75202-2799, US

(73) Assignee: PEROT SYSTEMS CORPORATION

(21) Appl. No.: 09/860,350

(22) Filed: May 17, 2001

(51) Int. Cl. G06F 17/60

(52) U.S. Cl. 705/37

(57) ABSTRACT

A system and method for processing bids of an auction by electricity market participants for electricity market commodities. The method includes retrieving model parameters and multiple bids for the electricity market commodities. The model parameters and bids are applied to equations representative of an electricity market, where the equations include at least one variable to be optimized. The equations are simultaneously solved for the variable(s). In simultaneously solving for the variable(s), the equations are iteratively solved to optimize the variable(s) according to a predetermined objective. Results of the auction are published to notify the market participants. The electricity market commodities include electric energy, reserve capacity, and transmission.

### BACKGROUND OF THE PRESENT INVENTION

1. Field of the Invention

The present invention relates generally to electricity markets, and more particularly, but not by way of limitation, to a method and system for conducting auctions for electricity markets.

2. Description of the Related Art

Electricity markets around the world have evolved over time due to deregulation, technological advances, and business climate changes. Individual countries and, often, states of the countries have different business practices for their electricity markets (i.e., the buying and selling of electricity and related services). In North America, for example, prior to 1996, most utility companies procured a substantial portion of their electric energy either by generating the electricity internally using their own generators (e.g., coal burning power plant) or by purchasing energy from neighboring utilities. Furthermore, ancillary services necessary for providing electricity, such as reserve capacity, were rarely thought of as an exchangeable commodity.

As understood in the art, ancillary services are services other than scheduled electric energy that are required to maintain system reliability and meet certain operating criteria. The ancillary services include, spinning reserve capacity, non-spinning reserve capacity, and regulation. Spinning reserve capacity is the portion of unloaded reserve capacity of electric equipment that is connected to an electric power grid. Non-spinning reserve capacity is the portion of unloaded reserve capacity of electric equipment that may not be connected to, but is capable of being connected to the electric power grid within certain time frame. Regulation is the portion of a generating unit's unloaded capability that may be loaded, or generating unit's loaded capability that may be unloaded, in response to automatic generation control signals or from a system operator.

Ancillary services were usually treated as a by-product of generation capability. This meant that, ancillary services were provided mainly from a utility's own generation and very rarely purchased from outside entities, such as neighboring utilities or independent generators.

Costs of purchasing electric energy from independent generators were primarily determined based on regulatory formulas, and costs of purchasing from neighboring utilities were mainly based on bilateral agreements between the neighboring utility parties, where the prices were based on a price range acceptable by regulators. For example, a utility requiring additional electric energy would negotiate a certain quantity and price for such energy from a neighboring utility or independent generator, where the transaction price was regulated to be within a narrow range.

Furthermore, after the utility had procured the electric energy, the utility would then try to find available transmission capacity from transmission service providers, usually neighboring utilities, so that the electric energy purchased could be delivered to the utility's customers (i.e., loads). The utility would then coordinate a schedule (i.e., the planned hourly pattern of generation output) with the transmission service providers for delivery of the electric energy. The price of providing transmission capacity would be set based upon the transmission rate tariffs regulated by a government body and not based on market value.

Hence, these transactions of electric energy and transmission capacity occurred in a disjointed fashion and were often arranged based on ad hoc communications and negotiations. Basically, a true market did not exist.

Since 1998 in some areas of the United States, such as California, Pennsylvania, New England and New York, deregulation of the electricity market was introduced. In these deregulated electricity markets, clearing auctions have been mainly used to determine the energy and ancillary service schedules of generators and inter-utility exchanges. In these auction markets, electric energy, ancillary services, including various types of reserve capacity, and transmission, are treated as different commodities. Reserve capacity is no longer simply treated as a by-product of energy generation, but an independent market commodity unto itself. Although the costs of providing transmission service remain regulated, a market of pricing hourly usage of transmission has been developed to allow efficient utilization of limited transmission resources.

Additionally, competition was introduced into the marketplace by allowing sellers of electric energy commodities (i.e., electric energy, reserve capacity, and transmission) to demand market value for their commodities so long as there is no appearance of market power, meaning that sellers cannot dictate prices or extract a scarcity rent from buyers. Therefore, the deregulation of the electricity industry has made it possible for each electricity commodity to have a distinct market value independent of the other electricity commodities.

As previously mentioned, electricity markets have been mainly developed based on a clearing auction concept. A clearing auction is a sealed auction, where a buyer submits an offer to buy the commodity and a seller submits a bid to sell the commodity; the bids may be matched through an electronic and automatic matching procedure. After the auction closes, a calculation is made to determine the results of the auction, which include winners and winning quantities of the buying and selling bids and clearing prices to be paid by the buyer to the seller, usually indirectly. The clearing price is the price at a location at which supply equals demand, where all demand at or above this price has been satisfied, and all supply at or below this price has been purchased.

In the electricity market, the winning quantities of the buying and selling bids are often submitted to a system or market operator for physical delivery, and, thus, these quantities are often called schedules or scheduled quantities. A market operator is an independent agency responsible for conducting electricity markets by collecting offers from suppliers and bids from purchasers. The market operator determines market prices and winning quantities for electricity commodities, and settles financial accounts.

As described above, the electricity commodities are often traded separately and sequentially in practice. For example, in California, day-ahead energy schedules for the next 24 hours are determined by scheduling coordinators; transmission market and transmission capacity usages are managed and determined by the California Independent System Operator (ISO); and unloaded reserve capacities along with capacity price bids (e.g., regulations, spinning reserve, non-spinning reserve) are then submitted into the reserve markets administered by the ISO. Each electricity commodity market is independently auctioned (i.e., priced and scheduled at different times). As another electricity market example, in the power pool of England and Wales, dispatch orders and clearing prices for electric energy are determined using an unconstrained system marginal price that is set at the highest offer price of generating units being dispatched. However, when transmission constraints are detected, a constrained dispatch program is executed and schedules are adjusted. The rescheduling costs are then charged to consumers as an uplift charge. Similar arrangements exist in the electricity markets of other states and countries around the world.

Because each electricity commodity is separately and independently auctioned, inefficiencies for the electricity market as a whole is inevitable. A substantial reason for the inefficiencies is due to complex interactions between energy generation schedules, transmission constraints, and reserve capacity requirements that need to be accounted for in determining schedules and clearing prices.

The total payments of electric energy and reserve commodities from separate energy and ancillary auctions is accordingly inflated due to having separate auctions. From a standpoint of a market participant (i.e., an entity that participates in the electric energy markets through the buying and selling of electricity commodities), the schedule of electric energy and reserve are such that their payments are often not optimal for the given clearing prices because of the sequential and separate nature of the auctions. Hence, it is not possible to optimize the utilization of the resources and to determine the most efficient schedule and prices of the commodities due to the sequential and separate nature of the auctions.

Furthermore, bidding and scheduling processes for electrical resources that are located in many geographically scattered areas, and computing market clearing prices for the different but interrelated commodities are expensive and time consuming for both market participants and operators. Because of the separate markets for the three electric energy commodities, separate transactions have to be performed, leading to transactional inefficiencies of the market process.

### SUMMARY OF THE INVENTION

To overcome the inefficiencies caused by separate auctions for individual electricity market commodities and lack of optimized scheduling and pricing in an electricity market, the principles of the present invention include an integrated auction to allow market participants to submit bids to a single auction for multiple commodities in an electricity market. An optimization process is utilized to compute results of the auction for the electricity market, where computing the results may be simultaneous. In the optimization process, an electricity power grid under which schedules are to be rendered is mathematically modeled to provide an accurate representation of the electricity power grid characteristics. In addition, the market rules are also mathematically modeled to provide an accurate representation of the economic behavior of market participants. The explicit use of locational price variables in the mathematical model and innovative constraints make it possible for the schedules and prices of the electricity markets to be optimized, thereby substantially eliminating inefficiencies of the non-integrated auction for the electricity markets.

One embodiment according to the principles of the present invention includes a system and method for processing bids of an auction by electricity market participants for electricity market commodities. The method includes retrieving model parameters and bids for the electricity market commodities. The model parameters and bids are applied to equations representative of an electricity market, where the equations include at least one variable to be optimized. The equations are simultaneously solved for the variable(s). In simultaneously solving for the variable(s), the equations are iteratively solved to optimize the variable(s) according to a predetermined objective. Results of the auction are published to notify the market participants.

Another embodiment includes a method for conducting an auction for an integrated electricity market. The method includes opening a data collection process of the auction of the integrated electricity market to receive bids on electricity commodities from market participants. The bids on the electricity commodities, including electric energy, reserve capacity, and transmission, are received. The data collection process of the integrated market is then closed. The bids are simultaneously processed for determining the results of the integrated electricity market. The bids may then be reviewed and validated.

Yet another embodiment includes a system for conducting an auction for an integrated electricity market. The system includes a computer server operating the integrated electricity market coupled to a communication network. Multiple electronic devices are coupled to the communication network and are in communication with the computer server for submitting bids for electricity commodities. The electricity commodities include electric energy, reserve capacity, and transmission capacity. At least one database is coupled to the computer server, where the database(s) store the submitted bids, power grid model parameters, and electricity market parameters.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an exemplary system block diagram for operating an electricity market according to the principles of the present invention;

FIG. 2 is an exemplary flow diagram operated on the exemplary system block diagram of FIG. 1 for conducting and determining results from an auction and publishing the same for the electricity market;

FIG. 3 is a more detailed exemplary flow diagram of the auction according to FIG. 2;

FIG. 4 is a more detailed exemplary flow diagram of the method for determining the results of the auction according to FIG. 2;

FIG. 5 is an exemplary resource bid curve as determined by the method for determining the results of the auction according to FIGS. 2 and 4;

FIG. 6 is a first embodiment of an exemplary electric power grid having two locations and associated market parameters, the exemplary electric power grid providing a structural example for operation of FIGS. 1-5; and

FIG. 7 is a second embodiment of a more complex exemplary electric power grid having three locations and associated market parameters, the more complex exemplary energy grid providing a more elaborate structural example for operation of FIGS. 1-5.

### DETAILED DESCRIPTION OF THE DRAWINGS

The present invention will now be described more fully hereinafter with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art.

Presently, processing of clearing auctions by an electricity market operator for electricity related commodities, including electrical energy, reserve capacity, and transmission capacity, are performed separately and sequentially because the electricity commodities are traded in separate markets. Because the electricity markets are separate, inefficiencies in determining schedules and prices are inherent.

To substantially eliminate inefficiencies in the electricity markets, an integrated market for the electricity commodities is formed to simultaneously process the bids to determine schedules and prices for the electricity commodities. The integrated market operates in the following manner: the data collection process of the market is opened, bids for the commodities from market participants are received, and the data collection process is closed. The bids are validated and processed using a mathematical model to determine auction results, which includes scheduling quantities and locational clearing prices (i.e., the clearing prices at a specified geographic location) for the commodities.

The processing and computation of the mathematical model composed of simultaneous equations includes performing an optimization process by (i) formulating the mathematical model utilizing electric power grid parameters, electricity market rules and parameters, and bid data, and (ii) solving for solutions to the mathematical model. The mathematical model includes objective function(s) of the auction and equality and inequality constraints that describe market rules and constraints and the physical operation of the underlying physical system (e.g., electricity power grid). Market rules described by the mathematical model are to be met by solution variables. The solution variables to the mathematical model include scheduling quantities, and locational clearing prices for the commodities, and control variables related to the electricity power grid model. The electricity power grid is a system of interconnected power lines, generators, and other electric equipment that are managed so that the generators are dispatched as needed to meet the requirements of customers connected to the electricity power grid at various points.

The computation of the mathematical model operates on a computing unit (e.g. processor) that is connected to a data network (e.g., the Internet). The market participants submit bids for the commodities electronically via an electronic interface of an electronic device. Because of the integrated nature of the market, each bid may include combination bids or bids on multiple electricity market commodities of the electric energy and reserve capacity. The electronic devices include computers, facsimile devices, telephones, and personal communication devices, for example. The bids may be stored in a database coupled to a server computer for retrieval during processing of the bids.

The processing of the bids and computation of the mathematical model to determine the results of the auction include: retrieving and applying mathematical model parameters (e.g., electric power grid and electricity market), applying bid data to the model equations, and solving for variables iteratively so as to optimize the objective function according to a predetermined objective, such as total consumer payment. The equations are simultaneously solved until changes in variables being solved are smaller than predefined tolerance(s). Locational price variables, control variables, objective function(s), and constraints of an electricity power grid and/or electricity market rules and constraints are included in forming the mathematical model equations.

After the processing of the bids for the auction, the results are published. The results may include public and private information, where the public information, such as locational clearing prices, may be openly shared with all market participants. Private information, such as schedules and bid data of a market participant, on the other hand, cannot be openly shared with all market participants. The public information may be posted on a public location, such as a public website, and the private information may be published on a private location, such as a website requiring an access password, or electronically communicated (e.g., e-mail) directly to the market participant.

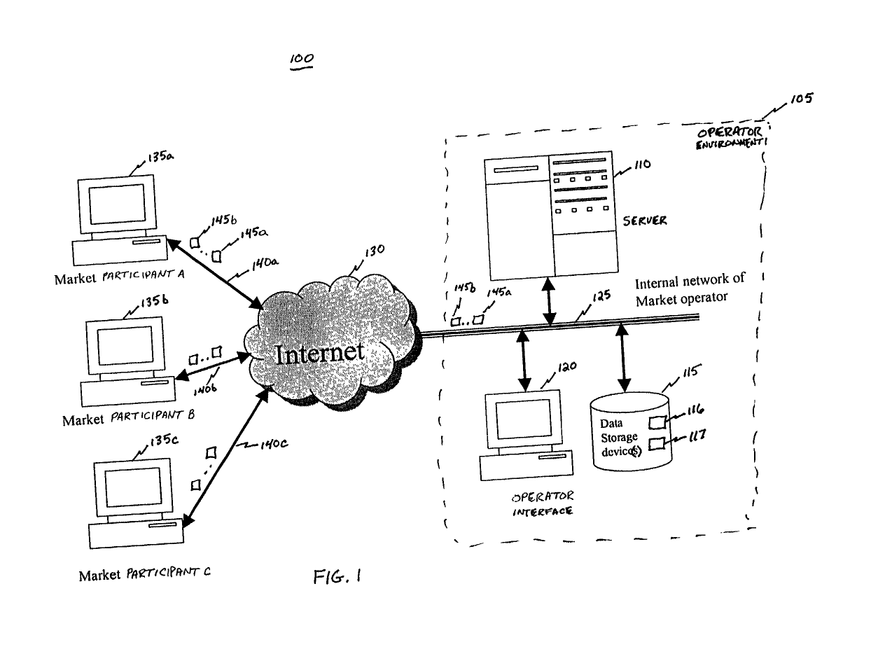

FIG. 1 is an exemplary system block diagram 100 for operating an electricity market according to the principles of the present invention. A market operator system 105 for conducting an auction, includes a computer server 110 coupled to at least one data storage device 115. The storage device(s) may include a bid database 116 and a model parameter database 117. Alternatively, the bid 116 and model parameter 117 databases may be a single database or split into several databases. An operator interface 120 is further coupled to the server 110 via an internal network 125, which may be a local area network (LAN), for example.

The bid 116 and model parameter 117 databases are utilized by the operator of the integrated electricity market for conducting the auction. The term “auction” is defined as including: (i) a data collection process (i.e., receiving the bids), (ii) processing the bids to determine the results of the auction, and (iii) publishing the results of auction. The bid database 116 includes bid information tendered by market participants during the auction. The bid information may include, for example, a set of points defining price and quantity curves, and a combination of electric energy quantity and reserve capacity range. Further, the bid data may include a set of constraints defining relations between electric energy schedules when more than one time interval is available.

The model parameter data stored in the model parameter database 117 may include power grid parameters, locational price variables, control variables, constraints, energy and reserve schedules. The locational price variables include locational energy price, locational reserve price, and transmission path prices for use by electric energy and reserve capacity. The locational price variables may also include multiple intervals if the auction is conducted for commodities with multiple time intervals or may be an aggregate of electricity power grid connections, where the electricity power grid connections are modeled as buses or locations in an electricity power grid model. The control variables may include schedulable quantity of bids, bus angle, electric energy usage across transmission paths, and capacity use of transmission paths. The objective may include total consumer payment (i.e., in the aggregate), for example. The constraints may include equality constraints and inequality constraints. The equality constraints may be power flow balance, power grid network price, and market rules. The inequality constraints may include bid sufficiency, flow limits, interface limits, and schedule limits. The bid sufficiency is a condition in which buy bidders pay not more than their own bid prices and supply bidders receive payment of at least their own bid prices.

The server 110 is coupled to a network 130, which may be a wide area network (WAN), such as the Internet. The network 130 is utilized to communicate with market participants 135a-135c (collectively 135). While the market participants 135 are shown as computing devices (e.g., personal computers), the market participants 135 alternatively may be coupled to the network 130 via a computing device, such as a server, or communication device, such as a facsimile, telephone, or personal communication device.

In operation, the communication device 135a connects to the network 130 via a network link 140a and transmits data packets 145a-145b, for example, which may include bid data when the market participant submits a bid to the market operator 105. After determining results of the auction, results data may be posted and/or communicated from the market operator 105 to the market participants 135 via data packets 145a-145b across the network 130.

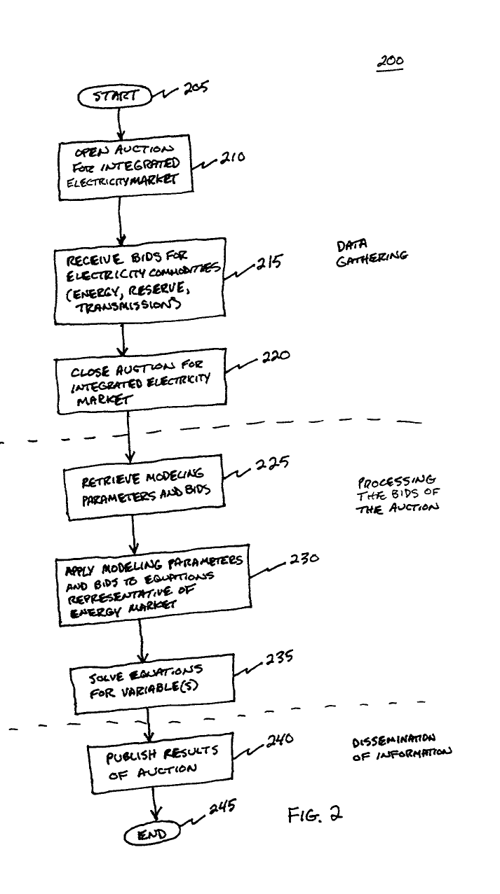

FIG. 2 is an exemplary flow diagram 200 for conducting and determining results of the auction of the integrated electricity market. Three basic stages of the auction process are shown, (i) data gathering, (ii) processing the bids of the auction, and (iii) dissemination of information. The process starts at step 205. At step 210, the auction for the integrated electricity market opens. Bids by the market participants 135 for the electric energy commodities are received by the market operator 105 at step 215. Because the electricity market is integrated, the bids to the auction may include each electricity energy commodity (i.e., electric energy, reserve capacity, and transmission). At step 220, the integrated energy market closes the auction.

At step 225, bid and model parameters are retrieved from databases 116 and 117, respectively. The bids and model parameters are applied to a set of simultaneous equations representative of the integrated electricity energy market at step 230. The simultaneous equations are used to model the electricity market and the power grid that defines the infrastructure of the electricity market. At step 235, the server 110 solves for the variables of the simultaneous equations, where the variables include scheduling quantities and location clearing prices for the commodities and control variables related to the electricity power grid model. At step 240, the public and private results of the auction are published. The process ends at step 245.

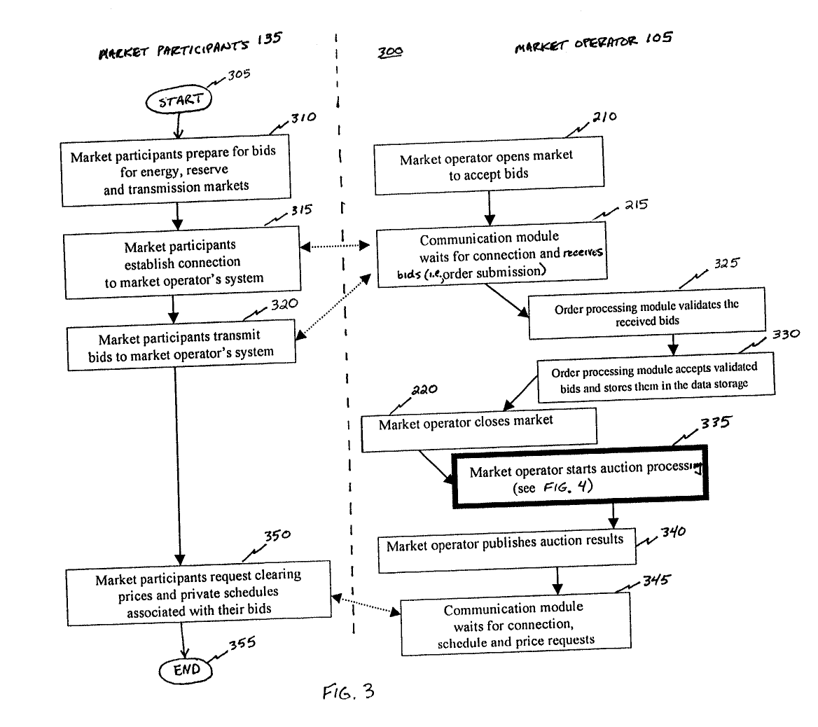

FIG. 3 is a more detailed exemplary flow diagram 300 of the auction process of FIG. 2, including both the market participants 135 and market operator 105. The process starts at step 305. At step 310 market participants prepare bids for electric energy commodities, including electric energy, reserve capacity, and transmission. At step 315, the market participants establish a connection to the server 110 of the market operator via the network 130. At step 210, the market operator opens the market to accept bids for the auction from the market participants 135. At step 215, the server 110 communicates with the market participants 135 and receives the bids (i.e., order submissions) for the electric energy commodities.

A bid from a market participant 135 may include multiple bids for each electricity commodity. For example, if the commodities are sold in time intervals, such as hourly, then a bid may include bids for each commodity for each hour of a 24-hour period. Alternatively, a bid may be submitted for only a single time interval. Further still, a bid may be submitted for the commodities in the aggregate.

At step 320, market participants transmit bids via the network 130 to the server 110 of the market operator 105. At step 325, the received bids are validated by the server 110, where the validation includes performing checks on location, schedule, price, and authenticity, for example. At step 320, the bids are stored in the bid database 116. It should be understood that while the auction of the electricity market remains open, market participants are able to submit bids for any of the electricity market commodities. At step 220, the market operator closes the auction for the electricity market.

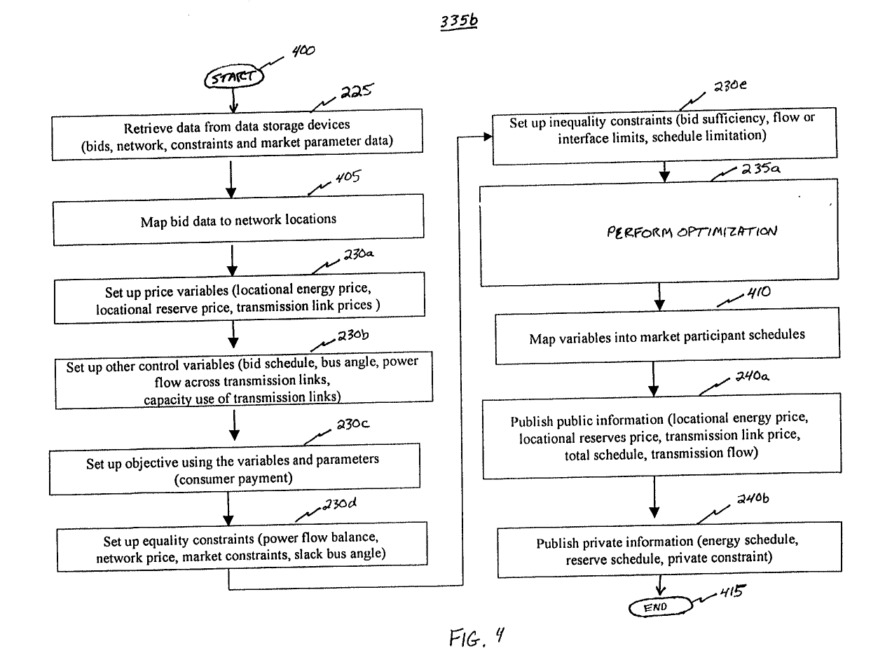

At step 335, the market operator 105 processes the bids for the auction of the electricity market via the server 110. The processing of the auction is described further herein with respect to FIG. 4. Once the processing of the auction is complete, the market operator 105 publishes the results of the auction at step 340. The results of the auction include both public and private information, where the public information may be posted on a public site (e.g., website). The private information may be published on a private site, which may require a password for access, for example, or may be electronically communicated to the market participants 135. Additionally, at step 345, the server 110 of the market operator 105 waits for requests for schedule and price results from the auction, and at step 350, the market participants 135 request clearing prices and private schedules associated with their bids. At step 355, the process ends.

FIG. 4 is a more detailed exemplary flow diagram 335 of FIG. 2 of the method for determining the results of the auction according to step 335 of FIG. 3. The process starts at step 400. At step 225, data is retrieved from the databases 116 and 117 from the data storage device(s) 115. The data may include bids, electricity power grid data, constraints, and market parameter data. Bid data is mapped to network locations at step 405.

The model parameters are next applied to the simultaneous equations (i.e., mathematical model) in steps 230a-230e. At step 230a, price variables are set up or initialized in the simultaneous equations. The price variables include locational energy prices, locational reserve prices, and transmission path prices. At step 230b, control variables are set up. The control variables include bids schedules, bus angle, power flow across transmission paths, and capacity use of transmission paths. At step 230c, an objective, such as total consumer payment, is set up. Equality constraints are set up at step 230d, where the equality constraints include power flow balance, network price, market constraints, and slack bus angle. At step 230e, inequality constraints, which include bid sufficiency, flow or interface limits, and schedule limitations, are set up.

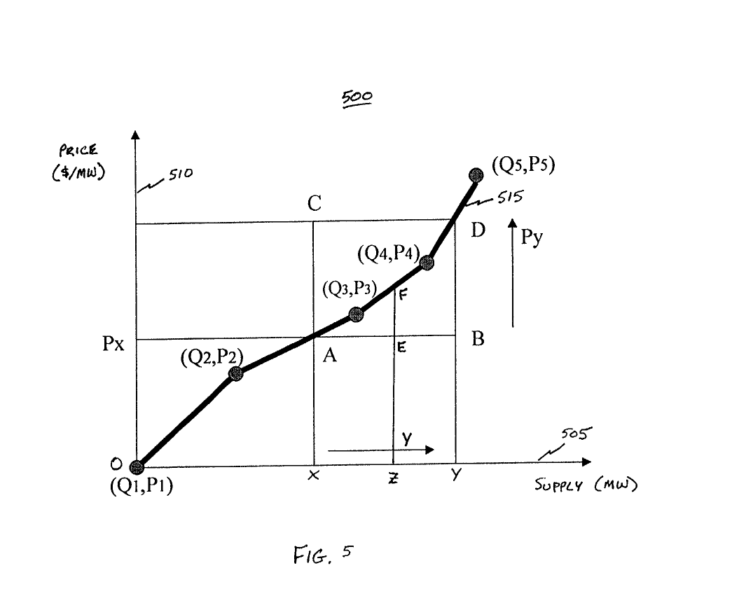

Referring to FIG. 5, resource bid curve 500 is shown. The resource bid curve 500 is formed by a submitted bid from a market player 135a, where each quantity/price point (e.g., (Q2, P2)) represents a quantity Q2 of an electric commodity that the market player is willing to sell for a minimum price P2. The submitted bid by the market participant 135a is assumed to be a monotonically increasing and non-negative price curve as a function of output quantity.

The resource bid curve 500 specifies the minimum price that the bidder will accept for the unit to operate at that level. The curve is also used by the market operator 105 to schedule reserve capacity and to compute reserve clearing prices. To use the resource bid curve 500 to schedule the reserve capacity and reserve clearing prices, the market operator 105 utilizes the points submitted by each market participant 135a-135c in determining the winning bids. In other words, the market operator 105 applies the quantity/price points submitted in the bids by the market participants 135a-135c to the simultaneous equations representative of the electricity market in computing the winning bids. Further, the energy payment from the reserve capacity, when being called upon during real-time operation, is equal to or more than that of the forward energy clearing prices.

Referring again to FIG. 4, at step 235a, an optimization process is performed on the set of simultaneous equations by steps 230a-230e and shown hereinafter with regard to equations (1)-(15). In performing the optimization process, the direction of a variable change vector is computed, the variable is adjusted iteratively along the direction of change of variables to be optimized until the change becomes smaller than a predefined tolerance. Essentially, the optimization process 235a solves the simultaneous equations for the variables to be optimized. It should be understood that other optimization techniques may be utilized to solve for the simultaneous equations.

The variables generally to be computed are locational energy and reserve capacity price and schedule, but other variables, such as energy and reserve capacity surplus, may also be computed while solving the simultaneous equations. The energy and reserve capacity surplus, or network surplus, is the payment difference by the buyers and sellers in the auction for the electricity commodities. The network surplus may not be zero for the auction because of the use of location clearing prices.

At step 410, the variables solved for in step 235a are mapped into schedules for market participants 135 to determine the results of the auction. At step 240a, public information, based on the results of the auction, may be published. The public information may include locational energy price, locational reserve price, transmission path price, total schedule, and transmission flow. At step 240b, private information, based on the results of the auction, may be published. The private information may include energy schedule, reserve schedule, and private constraint. The process ends at step 415.

To illustrate other possible embodiments of the instant invention, a few assumptions are made about the market structures described herein. These assumptions are intended to elaborate the proposed simultaneous equations (i.e., algorithm and solution); however, the algorithm and solution are not necessarily limited by the assumptions.

Specifically, the following market rules are applied in generating the simultaneous equations that are used to optimize an objective function. A reserve market is assumed, and the impact of ramp rate is ignored. A DC transmission system model is used and the B matrix is symmetric (i.e., no phase shifters). Schedules of different time periods are independently calculated, meaning that hourly generation schedules are determined independently. Both energy and capacity demands are known. Market operators are payment neutral, which means that the net payment is zero for market operators. Congestion related network surplus, if any, is paid to transmission owners. Clearing price principles apply to the electricity markets.

One embodiment of a formulation or set of simultaneous (objective) equations that may be utilized to generate results of the auction for the integrated electricity market is presented in equations (1)-(15) below. The simultaneous equations form a minimization or optimization problem that may be solved by iteratively computing the variables until changes in the variables being computed are below at least one predetermined threshold. The variables to be computed are PX, Pₓ, P_{y}, X, Y, qₓ, q_{y}, βₓ and β_{y}. An objective function or equation to be minimized is the total consumer payment as shown in equation (1).

Minimize (Pₓ^{t}Dₓ+P_{y}^{t}D_{y}) (1)

where a solution to the objective function is subject to the equality and electric energy inequality equations of equations (2)-(15), which model the power grid and market.

Bθₓ=X−Dₓ (2)

Bθₓ=X−Dₓ (3)

θ_{X}¹=0 (4)

θ_{Y}¹=0 (5)

X, Y, P_{X}, P_{Y}, β_{X}, β_{y}≧0 (6)

F(θ_{X})=I_{B}A^{t}θ_{X}≦Fₘₐₓ (7)

F(θ_{X}+θ_{Y})=I_{B}A^{t}θ_{XY}≦Fₘₐₓ (8)

C(X)≦Pₓ^{b} (9)

C(X+Y)−C(x)≦_{y}^{b} (10)

X+Y≦Qₘₐₓ (11)

BP_{X}−AI_{B}βₓ=0 (12)

BP_{y}−AI_{B}β_{y}=0 (13)

Σ_{k⊂J(k)}(xₖ−dₖ)=0 (Optional) (14)

Σ_{k⊂J(k)}(yₖ−aₖ)=0 (Optional) (15)

The variables in the equations are defined as:

| | |
|---|---|
| K | Number of generators. |
| X | Generation energy output vector. |
| Y | Generation reserve capacity vector. |
| C | Bidding price (function of X and Y) vector. |
| Qₘₐₓ | Maximum generation vector. |
| N | Number of buses in the network model. |
| M | Number of branches in the network model. |
| θₓ | Voltage angle vector due to energy schedule only. |
| θ_{y} | Voltage angle vector due to reserve use. |
| Dₓ | Energy demand vector. |
| D_{y} | Reserve demand vector. |
| Pₓ | Energy clearing price vector at each bus. |
| P_{y} | Reserve capacity clearing price at each bus. |
| Pₓ^{b} | Energy clearing price for generators. |
| P_{y}^{b} | Reserve capacity clearing price for generators. |
| Fₓ | Branch flow vector due to energy schedule only. |
| F_{y} | Branch flow vector due to reserve schedule only. |
| F_{xy} | Branch flow vector due to both energy schedule and reserve uses. |
| Fₘₐₓ | Branch flow maximum limit vector. |
| βₓ | Branch congestion cost vector of energy schedule. |
| β_{y} | Branch congestion cost vector of reserve schedule. |
| B | DC network admittance matrix (symmetric) ignoring branch |
| | resistance. |
| A | Network incidence matrix. |
| I_{B} | Diagonal matrix with diagonal elements being the reciprocal of |
| | branch admittance. |
| J(·) | Indices for identifying balanced generation and demand resources |

The objective in equation (1) represents the total payment by consumers in the aggregate. The payment is computed as an inner product of demand vectors with the clearing price vectors for each commodity (in this case, commodity includes electric energy and reserve capacity). The same clearing prices are used to pay suppliers and charge consumers. Consequently, the total payment from consumers is the same as the payment credited to generators when transmission congestion is not present.

The electricity power grid model for the transmission system is represented by equations (2) and (3), which describe network balance for energy and reserve capacity schedules, respectively. Voltage angles of a reference bus are set using equations (4) and (5). Equation (6) ensures that all price and schedule variables are positive.

Transmission branch flow limits are enforced by equations (7) and (8). These limits are applicable to both energy schedules and total schedules (energy and reserve).

Behaviors of profit maximizing market participants placing bids are modeled by equations (9) and (10). These constraints ensure that the energy and reserve clearing prices are no less than the bids of the market participants. Consequently, all generators are sufficiently compensated with the final clearing prices. Equation (11) is used to enforce generation output limit. Equations (12) and (13) are network price constraints, which link the clearing prices at different buses to satisfy network surplus requirements. Network surplus is defined as the difference of total payment received from demand users and credited for suppliers. When there is no transmission congestion, constraints of equations (12) and (13) ensure that the clearing prices at the buses are identical and the network surplus is zero.

Equations (14) and (15) are optional market separation constraints. These constraints, if enforced, ensure that a set of energy schedules or capacity reserves are balanced for market participants. The energy schedules may be used in modeling bilateral trading arrangements. In California and Texas, for example, energy schedules for each scheduling coordinator are balanced.

An electric power generator or market player 135a potentially receives three payments, (i) forward energy, (ii) reserve capacity, and (iii) real-time energy (if called). For a unit whose price bid is equal to the market clearing price, marginal unit, whose forward energy schedule is X, total schedule is X+Y, and real-time instructed output is Z, the three payments are represented by the areas of OP_{X}AX, respectively (see FIG. 5).

The formulation by equations (1)-(15) provides for an integrated electricity market that includes (i) price clarity and simplicity, (ii) competition for transmission usage, (iii) reduced transaction costs, and (iv) modeling of distribution reserve requirement. The properties are discussed further below.

Price clarity and simplicity: The explicit use of pricing variables provides price clarity to the market participants. With the traditional method of scheduling, prices are often computed as the by-products of the solution process. In contrast, the formulation set forth herein by the equations uses prices as control variables for scheduling and no separate process is needed for clearing price computation. With these prices, each bidder's profit is maximized. In addition, opportunity costs are often needed to compensate for re-dispatched or constrained generators by market operators 105. In the past, use of opportunity costs has been very controversial and often adds to price ambiguity. However, with the instant formulation as described herein, there is no need for computing these opportunity costs.

Competition for transmission usage: The instant formulation allocates transmission to energy and reserve use according to the economic bid data rather than heuristics. Therefore, market operators know, rather than having to guess, the amount of transmission that needs to be set aside for reserve use.

Reduced transactions costs: A large amount of transactional costs are incurred for market participants and operators as the process of market operations becomes more complex. With the instant formulation, transactions for market operators 105 and participants 135 are straightforward and associated transaction costs may be reduced. For instance, market participants 135 may submit one bid curve for all three markets, thus simplifying the data processing and management. A buyer of electricity market commodities submits a demand bid curve, which indicates a set of maximum prices for a corresponding set of quantities that the bidder is prepared to pay. A seller of electricity market commodities submits a supply bid curve, which indicates a set of minimum prices for a corresponding set of quantities that the bidder is prepared to accept. Furthermore, iterations between the constrained and unconstrained market prices may be eliminated.

Modeling of distributed reserve requirement: The instant formulation allows modeling of the distributed reserve requirements at different locations. Reserve requirements, in general, are the total reserve capacity demand in an electricity power grid. Although the reserve requirements are often proportional to energy demand, there are cases that some areas may have more reserve requirements.

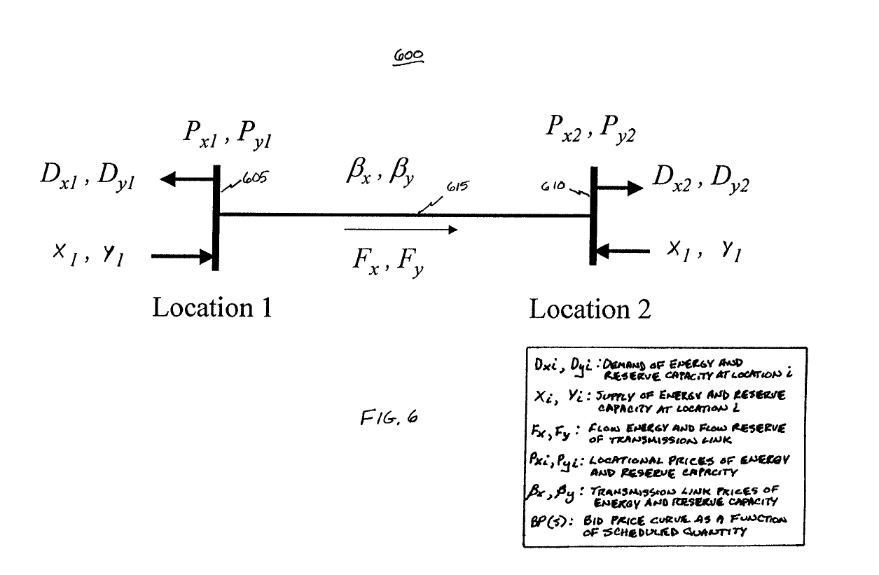

FIG. 6 is a first embodiment of an exemplary electricity power grid 600 having two locations and associated electricity market parameters (e.g., Dₓₗ, D_{yl}) The electric power grid 600 includes a first location or bus 605 and a second location or bus 610. A transmission line 615 couples the two locations 605 and 610. The electricity market parameters P and β are prices to be charged and/or received by the market participants 135 that are determined by the market operator 105 by solving the simultaneous equations (e.g., equations (1)-(15) that model the electricity power grid 600 and market parameters. The simultaneous equations that model the electricity power grid 600 are discussed below. Note, to simplify the example, no market separation constraints are applied.

The exemplary electricity power grid 600 includes only two locations (i.e., buses) connected in series to provide a simplistic understanding as to application of the simultaneous equations (1)-(15). Similar to equation (1) of the simultaneous equations previously discussed for the formulation of the optimization problem for conducting an auction for the integrated electricity market, total consumer payment is computed by the equation, Pₓ₁Dₓ₁+Pₓ₂Dₓ₂+P_{y1}D_{y1}+P_{y2}D_{y2}, where the total consumer payment for the model of the electricity power grid 600 having two locations is an inner product of demand vectors with clearing price vectors. Because there are only two locations, the full expression may be easily shown for exemplary purposes. By minimizing total consumer payment, both generation payment and transmission congestion costs are reduced.

Further shown by the two location model is the constraint that total energy and reserve capacity demands are equal to total energy supply, X₁+X₂=Dₓ₁+Dₓ₂ and Y₁+Y₂=D_{yl}+D_{y2}. Another constraint of the two location model is that locational energy and reserve capacity balance is preserved, X₁−Dₓ₁=Fₓ and Y₁−D_{y1}=F_{y}. Inequality equations provide that transmission path flow is limited, Fₘₐₓ≧Fₓ and Fₘₐₓ≧Fₓ+F_{y}.

Similar to equation (12), which provides for network price constraints, clearing prices at each location are linked to the network surplus requirements by equations, b₁(Pₓ₂−Pₓ₁)=βₓb₁ and b₁(P_{y2}−P_{y1})=β_{y}b₁, where b₁ is the admittance of the transmission path between location 1 and location 2. These or similar equations make it possible to integrate the electric energy market by including each of the electricity market commodities.

Yet another constraint is bid sufficient constraint, which is formed using the bid resource curve 500 provided by market participants operating locations 1 and 2. The bid sufficient constraints are similar to equations (9) and (10) of the simultaneous equations and are given for the two location model as:

Pₓ₁≧C₁ (S₁)

P_{y1}≧C₁ (X₁+Y₁)−C₁ (X₁)

Pₓ₂≧C₂ (X₂)

P_{y2}≧C₂ (X₂+Y₂)−C₂ (X₂)

The transmission rent is a variable computed by the equation, βₓFₓ₊β_{y}F_{y}, and supplier payment is computed by Pₓ₁X₁+Pₓ₂X₂+P_{y1}P_{y2}Y₂. Both transmission rent and supplier payment are price variables that are optimized by iteratively computing the simultaneous equations until the variables being computed are below predetermined thresholds.

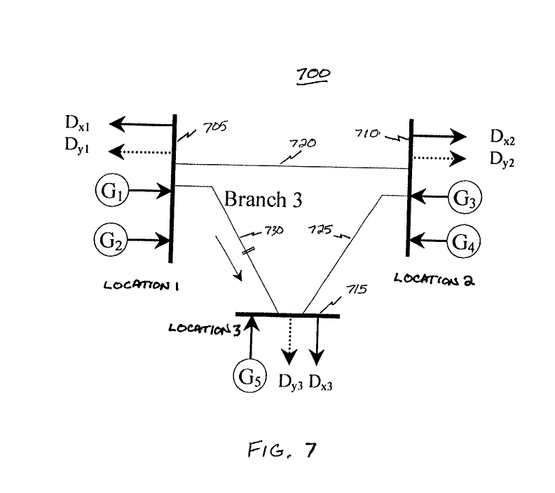

FIG. 7 is a second embodiment of a more complex exemplary electricity power grid 700 having three locations (i.e., buses) 705, 710, and 715 and associated market parameters (e.g., Dₓ₁ D_{y1}), the more complex exemplary electricity power grid providing a more elaborate structural example for operation of FIGS. 1-5. Interconnecting the locations 1 and 2 is branch 720, locations 2 and 3 is branch 725, and locations 1 and 3 is branch 730. It should be understood that the locations are operated by a market participants 135 and are points or locations in the electricity power grid 700 that are used to determine market price for electricity.

One complexity not included in FIG. 6 is a loop structure of the electric power grid 700. By having a loop structure, additional model parameters are needed to accurately represent the electricity power grid 700. There exists five electric power generators G1-G5, where generators G1-G2 are coupled to location 1, generators G3 G4 are coupled to location 2, and generator G5 is coupled to location 3.

The bid price curve (not shown) is represented as c0+c1*q, where q is the output quantity. The bid parameter, energy and capacity demands used in the electricity power grid 700 are listed in TABLES 1 and 2. As indicated in TABLE 1, the demand parameters, Dx (i.e., electric energy demand) and Dy (i.e., reserve capacity demand), are provided for each location and not for each generator G1-G5. For simplicity, the three branches 720, 725, and 730 have equal impedances as indicated in TABLE 2. It should be understood that a bid price curve similar to the one shown in FIG. 5 may be drawn utilizing the bid price curve parameters, C₀, C₁, and Qₘₐₓ.

TABLE 1
Market and Bid Parameters

| Generator | | Bid Price Curve Parameters | | | Demand | |
|---|---|---|---|---|---|---|
| G1-G5 | Location | C0 | C1 | Qmax | Dx | Dy |
| 1 | 1 | 20 | 0.2 | 30 | 25 | 4 |
| 2 | 1 | 20 | 0.2 | 50 | | |
| 3 | 2 | 22 | 0.3 | 40 | 25 | 3 |
| 4 | 2 | 25 | 0.5 | 50 | | |
| 5 | 3 | 24 | 0.4 | 50 | 50 | 3 |

TABLE 2
Branch Parameters

| | From | To | | |
|---|---|---|---|---|
| Branch | Bus | Bus | Impedance | Fₘₐₓ |
| 1 | 1 | 2 | 0.1 | 30 |
| 2 | 2 | 3 | 0.1 | 30 |
| 3 | 1 | 3 | 0.1 | 30 |

Table 3 shows five result sets, Base Case and Cases A-D, with different demand and network parameters. The parameter changes from the Base Case in Cases A-D are indicated in bold fonts (e.g., the cell intersecting “Case A” and “Flow Limit from 1-3”), and are made to either electric model parameters (e.g., flow limit) of the electricity power grid 700 or market parameters, such as energy demand (i.e., forecast) or reserve capacity requirements. The remainder of the variables, including energy and reserve capacity prices (Pₓ, P_{y}), energy and reserve schedules (X, Y), energy and reserve flow (Fₓ, F_{y}), congested branch energy and reserve capacity cost (βₓ, β_{y}), surplus, and total consumer payment, are solved by the simultaneous equations (1)-(15). Note, to simplify the example, no market separation constraints are applied.

TABLE 3
Example Models and Results

| | Base | | | | |
|---|---|---|---|---|---|
| Description | Case | Case A | Case B | Case C | Case D |
| Energy price at Bus 1 (Pₓ¹) | 27.5325 | 26.5185 | 27.6481 | 27.5325 | 27.6481 |
| Energy price at Bus 2 (Pₓ²) | 27.5325 | 27.7778 | 28.4722 | 27.5325 | 28.4722 |
| Energy price at Bus 3 (Pₓ³) | 27.5325 | 29.0370 | 29.2963 | 27.5325 | 29.2963 |
| Reserve price at Bus 1 (P_{y}¹) | 0.7792 | 0.6704 | 0.6704 | 1.0823 | 0.3741 |
| Reserve price at Bus 2 (P_{y}²) | 0.7792 | 0.8056 | 0.8056 | 1.1898 | 1.3611 |
| Reserve price at Bus 3 (P_{y}³) | 0.7792 | 0.9407 | 0.9407 | 1.2972 | 2.3481 |
| Energy schedule of Unit 1 (X¹) | 30.0000 | 30.0000 | 30.0000 | 30.0000 | 30.0000 |
| Energy schedule of Unit 2 (X²) | 37.6623 | 32.5926 | 38.2407 | 37.6623 | 38.2407 |
| Energy schedule of Unit 3 (X³) | 18.4416 | 19.2593 | 21.5741 | 18.4416 | 21.5741 |
| Energy schedule of Unit 4 (X⁴) | 5.0649 | 5.5556 | 6.9444 | 5.0649 | 6.9444 |
| Energy schedule of Unit 5 (X⁵) | 8.8312 | 12.5926 | 13.2407 | 8.8312 | 13.2407 |
| Reserve schedule of Unit 1 (Y¹) | 0.0000 | 0.0000 | 0.0000 | 0.0000 | 0.0000 |
| Reserve schedule of Unit 2 (Y²) | 3.8961 | 3.3519 | 3.3519 | 5.4117 | 1.8704 |
| Reserve schedule of Unit 3 (Y³) | 2.5974 | 2.6852 | 2.6852 | 3.9658 | 4.5370 |
| Reserve schedule of Unit 4 (Y⁴) | 1.5584 | 1.6111 | 1.6111 | 2.3795 | 2.7222 |
| Reserve schedule of Unit 5 (Y⁵) | 1.9481 | 2.3519 | 2.3519 | 3.2429 | 5.8704 |
| Energy demand at Bus 3 (D³) | 50.0000 | 50.0000 | 60.0000 | 50.0000 | 60.0000 |
| Reserve requirements at Bus 3 | 3.0000 | 3.0000 | 3.0000 | 8.0000 | 8.0000 |
| (A³) | | | | | |
| Energy branch flow from 1 to 2 | 14.7186 | 12.5926 | 13.2407 | 14.7186 | 13.2407 |
| (Fₓ¹) | | | | | |
| Energy branch flow from 2 to 3 | 13.2251 | 12.4074 | 16.7593 | 13.2251 | 16.7593 |
| (Fₓ²) | | | | | |
| Energy branch flow from 1 to 3 | 27.9437 | 25.0000 | 30.0000 | 27.9437 | 30.0000 |
| (Fₓ³) | | | | | |
| Reserve use from 1 to 3 (F_{y}³) | 0.3160 | 0.0000 | 0.0000 | 2.0563 | 0.0000 |
| Flow limit from 1 to 3 (Fₘₐₓ³) | 30.0000 | 25.0000 | 30.0000 | 30.0000 | 30.0000 |
| Congested branch energy cost | 0.0000 | 3.7778 | 2.4722 | 0.0000 | 2.4722 |
| (βₓ³) | | | | | |
| Congested branch Reserve cost | 0.0000 | 0.4056 | 0.4056 | 0.3222 | 2.9611 |
| (β_{Y}³) | | | | | |
| Energy network surplus | 0.0000 | 94.4444 | 74.1667 | 0.0000 | 74.1667 |
| Capacity network surplus | 0.0000 | 0.0000 | 0.0000 | 0.6626 | 0.0000 |
| Total consumer payment | 2761.0390 | 2817.1796 | 3168.7074 | 2771.5227 | 3185.1519 |

As shown in TABLE 3, in the Base Case, transmission flow constraints are inactive, i.e., the transmission path flow is less than the maximum flow limit, resulting in uniform clearing prices for both energy and reserve markets, as well as a zero network surplus. Although the transmission constraints are inactive, constraints on locational prices are still playing an important role. Before solving for the schedules, transmission flows are unknown and congestion is undetermined. Simply allowing different locational prices as control variables, a condition may be determined where different locational prices are computed without any transmission limitation. On the other hand, predefined congestion and restrict trading between locations is used, economic efficiency due to the inter-locational trading may not be fully captured. To confirm these modeling concerns, the network price constraints in the Base Case are reviewed and prices and schedules are solved for using the simultaneous equations (1)-(15). In the new solution (not shown), total consumer payment (i.e., objective function) is reduced to be 2707.89, and the different energy (clearing) prices at the three buses are computed as (26.00, 28.37, 28.81). If 28.81 is chosen as the energy clearing price, the total energy payment from consumers alone is 2881, a less optimal solution than the Base Case.

In Case A, flow limit of branch 3 is restricted from 30 to 25. Branch 3 becomes congested since the unconstrained flow of energy branch flow between locations 1 to 3 (Fₓ^{3) is} 27.9437. This leads to reduction of output in location 1 and an increase of more expensive units of energy prices in locations 2 and 3. Consequently, higher zonal clearing prices at locations 2 and 3 are computed.

An examination of energy price at location 3 is now considered. When electric energy is delivered from location 1 to location 3, two thirds of the electric energy flows through branch 1 and one third flows through the parallel path on branches 1 and 2. At market solution, Pₓ³=Pₓ¹+⅔*βx. The clearing price at location 3 is a combination of the clearing price at location 1 and the transportation cost from location 1 to location 3. An energy network surplus of 94.4444 is the difference between demand payment and generator credit payment. The energy network surplus can also be computed by multiplying the total flow of branch 3 with the branch congestion price.

In Case B, examination of the results of the simultaneous equations (1)-(15) when the energy demand at location 3 increases from 50 to 60 is conducted. The total consumer payment is increased by 407.0084 to 3168.7074. This increase is due to three factors: energy network surplus, cost increase for additional generation, and additional payment due to price increases. Because of the increased demand, energy clearing prices at all locations are increased, with the largest increase occurring at location 3. However, reserve prices remain the same as in Case A.

Case C is rather interesting. The reserve demand at location 3 is increased from 3 to 8. Branch 3 is unconstrained for energy schedules. Hence, uniform energy clearing prices are computed for all three locations. However, there is not enough transmission to support reserve capacity use from locations 1 to 3. Therefore, a congestion branch reserve price of 0.3222 is assessed to the capacity reservation for this branch. Consequently, different clearing prices for reserve are computed and a capacity network surplus of 0.6626 (a product of reserve usage 2.0563 and congestion price 0.3222) is computed due to the insufficient transmission for reserve.

Referring now to Case D, reserve demand and energy demand at location 3 is simultaneously increased. Branch 3 is constrained for energy delivery, which results in different energy and reserve clearing prices for all three locations. The largest price increases for reserve is also at location 3. Because the energy demand is the same as in Case B, the energy clearing prices are the same as in Case B.

The previous description is of a preferred embodiment for implementing the invention, and the scope of the invention should not necessarily be limited by this description. The scope of the present invention is instead defined by the following claims.

What is claimed is:

1. A method for processing bids of an auction by electricity market participants for electricity market commodities, comprising:
retrieving model parameters and bid data for the electricity market commodities;
applying the model parameters and bid data to equations representative of an electricity market, the equations including at least one variable to be optimized;
simultaneously solving the equations for the at least one variable, said solving being performed iteratively to optimize the at least one variable according to a predetermined objective; and
publishing results of the auction to notify the market participants.

2. The method according to claim 1, wherein said solving computes schedules for the electricity market commodities.

3. The method according to claim 1, wherein said solving adjusts the at least one variable along a direction of change until a norm of changes of the at least one variable is smaller than a predefined tolerance.

4. The method according to claim 1, wherein the model variables include at least one of the following:
locational price variables, control variables, objectives, and constraints.

5. The method according to claim 4, wherein the locational price variables include at least one of the following:
locational energy price, locational reserve price, and transmission path prices.

6. The method according to claim 4, wherein the locational price variables are computed for multiple time intervals.

7. The method according to claim 4, wherein the locational price variables represent an aggregate of power grid connections, the power grid connections being modeled as buses in a power grid model.

8. The method according to claim 4, wherein the control variables include at least one of the following:
schedulable quantity of bids, bus angle, electric energy usage across transmission paths, and capacity use of transmission paths.

9. The method according to claim 4, wherein the objectives include consumer payment.

10. The method according to claim 4, wherein the constraints include at least one of the following:
equality constraints, including at least one of the following:
power flow balance, price, market constraints, and slack bus angle; and
inequality constraints, including at least one of the following:
bid sufficiency, flow limits, interface limits, schedule limits.

11. The method according to claim 1, further comprising matching the bid data to power grid locations.

12. The method according to claim 1, wherein said publishing includes posting solved solutions of the at least one variable.

13. The method according to claim 1, wherein the energy commodities include at least one of the following: electric energy, reserve capacity, and transmission usage.

14. The method according to claim 1, wherein a market participant submits a bid including a set of points defining a price and quantity curve including a combination of electric energy and reserve capacity range.

15. The method according to claim 1, wherein the auction results includes scheduled quantities and locational clearing prices.

16. A system for processing bids by electricity market participants of an auction for electricity market commodities, the system comprising:
a database including model parameters and bid data, the model parameters and bid data being applied to equations representative of the electricity market, the equations including at least one variable to be optimized;
a processor coupled to said database, the processor for simultaneously solving the equations for the at least one variable to be optimized, the solving being performed iteratively to optimize the at least one variable according to a predetermined objective; and
means for publishing results of the auction to notify the electricity market participants.

17. The system according to claim 16, wherein the at least one variable includes commodities, the commodities including electric energy, reserve capacity, and transmission capacity.

18. The system according to claim 17, wherein said processor adjusts the at least one variable along a direction of change until a norm of changes of the at least one variable being smaller than a predefined tolerance.

19. The system according to claim 16, wherein the model parameters include at least one of the following:
locational price variables, control variables, objectives, and constraints.

20. The system according to claim 19, wherein the locational price variables are computed for multiple intervals.

21. The system according to claim 19, wherein the locational price variables represent an aggregate of power grid connections, the power grid connections being modeled as buses in a power grid model.

22. The system according to claim 19, wherein the locational price variables include at least one of the following:
locational energy price, locational reserve price, and transmission path prices.

23. The system according to claim 19, wherein the control variables include at least one of the following:
schedulable quantity of bids, bus angle, electric energy usage across transmission paths, and capacity use of transmission paths.

24. The system according to claim 19, wherein the objectives include consumer payment.

25. The system according to claim 19, wherein the constraints include at least one of the following:
equality constraints, including the following:
power flow balance, power grid network price, market constraints, and slack bus angle; and
inequality constraints, including at least one of the following:
bid sufficiency, flow limits, interface limits, and schedule limits.

26. The system according to claim 16, wherein said processor further matches the bid data to power grid locations.

27. The system according to claim 16, wherein said means for publishing performs at least one of the following:
posts solved solutions of the at least one variable on an electronic media for the participants to retrieve, and
electronically communicates the solved for at least one variable to the electricity market participants.

28. The system according to claim 16, wherein said publishing includes at least one of the following: posting and electronically communicating at least one of the solved at least one variable.

29. The system according to claim 16, wherein the electricity market commodities include at least one of the following: electric energy, reserve capacity, and transmission usage.

30. The system according to claim 16, wherein the results of the auction include at least one of the following: scheduled quantities transmission usages, and locational clearing prices.

31. A method for conducting an auction for an integrated electricity market, the method comprising:
opening a data collection process of the auction of the integrated market to receive bids on electricity commodities from market participants;
receiving the bids on the electricity commodities, the electricity commodities including electric energy, reserve capacity, and transmission;
closing the data collection process of the auction of the integrated market; and
simultaneously processing the bids to determine results for the integrated electricity market.

32. The method according to claim 31, further comprising validating the bids for the integrated electricity market.

33. The method according to claim 32, wherein said processing includes performing an optimization process to determine the outcome of the auction.

34. The method according to claim 33, wherein the optimization process includes solving a set of necessary optimality conditions included in a set of simultaneous equations.

35. The method according to claim 31, wherein the bids for the integrated electricity market include at least one time interval for multiple commodities.

36. The method according to claim 31, further comprising publishing results from the auction.

37. The method according to claim 36, wherein the results include electric energy, reserve capacity, and transmission commodities.

38. The method according to claim 36, wherein the publishing includes at least one of the following:
posting the results of the computation on a electronic media; and
communicating the results to the market participants via an electronic communication.

39. The method according to claim 38, wherein the posted results include public information accessible by market participants.

40. The method according to claim 38, wherein the electronically communicated results include private information.

41. The method according to claim 38, wherein the electronic communication includes at least one of the following:
e-mail, text messaging, and facsimile.

42. The method according to claim 31, wherein a market participant submits a bid including a set of points defining a price and quantity curve, and the price and quantity curve including a combination of electric energy and reserve capacity range.

43. The method according to claim 31, wherein said market participants submit bids including a set of constraints defining relations between electric energy schedules.

44. The method according to claim 31, wherein results of the auction include at least one of the following:
scheduled quantities corresponding to each bid submitted, and
locational prices for electric energy, reserve capacity commodities, and transmission usage.

45. A system for conducting an auction for an integrated electricity market, the system comprising:
a computer server coupled to a communication network, said computer server operating the integrated electricity market;
a plurality of electronic devices coupled to the communication network, said electronic devices in communication with said computer server for submitting bids for electricity commodities, the electricity commodities including electric energy, reserve capacity, and transmission capacity; and
at least one database coupled to said computer server, said at least one database storing the submitted bids, power grid model parameters, and electricity market parameters, said computer server simultaneously processing the submitted bids to determine results of the auction.

46. The system according to claim 45, wherein said electronic devices include at least one of the following:
computer, facsimile, telephone, and personal communication device.

47. The system according to claim 45, wherein said server further publishes results of the auction available to said electronic devices.

48. The system according to claim 47, wherein the publishing of the results includes at least one of the following: posting on the communication network and electronically transmitting.

49. The system according to claim 45, wherein the processing includes iteratively solving a set of simultaneous equations.

50. The system according to claim 49, wherein the processing of the bids is performed after an acceptance time for new bids and bid modifications.

51. The system according to claim 49, wherein the processing of the bids includes an optimization process.

52. The system according to claim 45, wherein results of the auction include scheduled quantities of the electricity commodities, locational prices of the electricity commodities, and transmission usages.

53. The system according to claim 45, wherein market participants submit bids including:
a set of points defining price and quantity curves, and
and a combination of electric energy and reserve capacity range.

54. A computer-readable medium having stored thereon sequences of instructions, the sequences of instructions including instructions, when executed by a processor, causes the processor to:
retrieve modeling parameters and a plurality of bids for electricity market commodities;
apply the modeling parameters and bids to equations representative of an electricity market, the equations including at least one variable to be optimized;
solve the equations for the at least one variable, said solving being performed iteratively to optimize the at least one variable according to a predetermined objective; and
publish results of the auction to notify the market participants.

55. A method for participating in an integrated electricity auction conducted by a market operator for market participants, the method comprising:
establishing a communication link by a market participant with a market operator;
communicating a bid for electricity market commodities from the market participant to the market operator, the electricity market commodities including electric energy, reserve capacity, and transmission capacity; and
receiving results of the auction from the market operator by the market participant, the results being simultaneously generated.

56. The method according to claim 55, wherein the results of the auction include schedules for the electricity market commodities.

57. The method according to claim 55, wherein the results of the auction are received via an electronic communication.

58. The method according to claim 55, wherein the results of the auction are published on a publicly accessible location.

59. The method according to claim 55, wherein said receiving includes:
accessing a network location; and
entering a password at the network location to receive the results.

60. A computer-readable medium having stored thereon sequences of instructions, the sequences of instructions including instructions, when executed by a processor, causes the processor to:
establish a communication link by a market participant with a market operator;
communicate a bid for electricity market commodities from the market participant to the market operator, the electricity market commodities including electric energy, reserve capacity, and transmission capacity; and
receiving results of the auction from the market operator by the market participant, the results being simultaneously generated.

61. At least one computer programmed to execute a process for participating in an integrated electricity market in which a server computer operated by a market operator conducts an auction for electricity market commodities, the process comprising:
transmitting electronic signals to establish a communication link between a participating computer and the server computer;
generating at least one bid for the electricity market commodities including electric energy, reserve capacity, and transmission capacity; and
causing electronic signals representing the at least one bid to be sent to the server computer for submission of the at least one bid to be submitted to the auction, the bids being simultaneously processed to determine results of the auction.

62. The process according to claim 61, wherein at least one bid includes data representative of a price and quantity curve.

63. The process according to claim 61, further comprising:
determining results of the auction based on the at least one bid; and
causing electronic signals representing the results of the auction to be sent from the server computer to the participating computer.

64. At least one computer programmed to process bids submitted by market participants for electricity market commodities, the process comprising:
receiving electronic signals representing electricity market model parameters;
receiving electronic signals representing the bids submitted by the market participants;
applying the electricity market model parameters and bids to equations representative of an electricity market, and including at least one variable to be optimized;
iteratively computing solutions to the at least one variable until the at least one variable satisfies a predetermined objective;
determining results of the auction based on the at least one variable being optimized; and
causing electronic signals representing the results of the auction to be sent to publish the results of the auction.

65. The process according to claim 64, wherein the results of auction are published on an electronic network.

66. The process according to claim 64, wherein the bids include price and schedule information for electric energy, reserve capacity, and transmission.

67. A system for determining results of an auction conducted for electricity market commodities of an integrated energy market, the system comprising:
means for storing model parameter and bid data, the bid data including electric energy, reserve capacity and transmission information;
means for reading the model parameters and bid data from said means for storing;
means for utilizing the model parameters and bid data to determine results of the auction; and
means for publishing the results of the auction.
